(19) United States
(12) Patent Application Publication
(10) Pub. No.: US 2024/0187137 A1
(43) Pub. Date: Jun. 6, 2024

(54) SYSTEM AND METHOD FOR MANAGING AUDIO QUALITY IN A LOW ENERGY AUDIO BROADCAST SCENARIO

(71) Applicant: Samsung Electronics Co., Ltd., Suwon-si (KR)

(72) Inventors: Pramod Reddy SERIKAR, Bengaluru (IN); Gurumani Lakshmi Praneeth JUTURU, Bengaluru (IN); Shruthi SIRUR, Bengaluru (IN); Veerabhadrappa CHILAKANTI, Bengaluru (IN); Gowtham ANANDHA BABU, Bengaluru (IN)

(21) Appl. No.: 18/436,237

(22) Filed: Feb. 8, 2024

Related U.S. Application Data
(63) Continuation of application No. PCT/KR2022/012221, filed on Aug. 17, 2022.

(30) Foreign Application Priority Data
Aug. 23, 2021 (IN) 202141038114
Jul. 27, 2022 (IN) 2021 41038114

(51) Int. Cl. H04L 1/16; H04L 1/00

(52) U.S. Cl. CPC H04L 1/16; H04L 1/0009

(57) ABSTRACT

A method for managing the audio quality in an audio broadcast scenario performed by a source device is provided. The method includes reserving a receiver (Rx) slot in the source device to receive link quality feedback packets from one or more sink devices and transmitting Rx slot information to the one or more sink devices in a control subevent of a broadcast isochronous channels (BIS) event. The method further includes receiving the link quality feedback data packets from the one or more sink devices in the reserved Rx slot and determining a quality of a broadcast link between the source device and the one or more sink devices by scanning the received link quality feedback data packets and thereafter based on a result of the determination, optimizing at least one of a plurality of low energy (LE) isochronous parameters to manage audio quality and reliability of the broadcast link.

### CROSS-REFERENCE TO RELATED APPLICATION(S)

This application is a continuation application, claiming priority under § 365(c), of an International application No. PCT/KR2022/012221, filed on Aug. 17, 2022, which is based on and claims the benefit of an Indian Provisional patent application number 202141038114, filed on Aug. 23, 2021, in the Indian Intellectual Property Office, and of an Indian Complete patent application number 202141038114, filed on Jul. 27, 2022, in the Indian Intellectual Property Office, the disclosure of each of which is incorporated by reference herein in its entirety.

### BACKGROUND

### 1. Field

The disclosure relates to the field of low energy audio. More particularly, the disclosure relates to a system and method for managing audio quality in a low energy audio broadcast scenario.

### 2. Description of Related Art

The Bluetooth® Core Specification defined by the Bluetooth Special Interest Group (SIG) introduced the low-power audio transmission over Bluetooth called low energy (LE) audio. LE audio operates on the Bluetooth LE standard. Bluetooth SIG introduced a new feature in the latest specification version 5.2 called Isochronous Channels (ISOC). ISOC lays the foundation for the implementation of the LE Audio.

Isochronous channels are used to transfer time bounded data between devices. Multiple sink devices, receiving data from the same source, will render it at the same time. Isochronous channels may be connection-oriented or connectionless (broadcast). Broadcast Audio allows for one or multiple audio streams to be broadcast to an unlimited number of devices. It enables applications like Personal Audio Sharing where a user can share their audio stream, for example from a phone or tablet, with other user's headphones in the vicinity. Bluetooth LE Audio Isochronous channels are of two types (a) Unicast Connection Oriented Isochronous Channels (CIS Channels) and (b) Broadcast Isochronous Channels (BIS Channels).

The CIS channels are logical transport channels that enable connected devices to transfer isochronous data unidirectionally and bidirectionally. The isochronous data can be transferred either in a LE-Stream (LE-S) or LE-Frame (LE-F) logical link by using the CIS based logical transport. It can be also called a reliable transmission of isochronous data because the master device can keep retransmitting the isochronous data packet until it receives an acknowledgment from the slave device. Further, since isochronous channels are used to transfer time bounded data, the isochronous data packet will be flushed after a flush timeout. This number can be set dynamically based on link quality/RF interference (Max 255 CIS events).

The BIS channels are logical transport channels that enable a broadcasting source device to transfer isochronous data (framed or unframed). The BIS channels support variable-size packets and the transmission of one or more packets in each isochronous event, enabling LE audio to support a range of data rates. The data traffic is unidirectional from the broadcasting source device. Therefore, no acknowledgment protocol exists, making broadcast isochronous traffic unreliable. To improve the reliability of the packet delivery, the isochronous data packets can be unconditionally re-transmitted determined by the parameter: IRC (“Immediate Repetition Count”. This number is set once in the range 1 to a Number of Subevents ((NSE) per BIS event/a number of payloads (Burst Number (BN)) available per BIS event. There is no link quality indicator available to dynamically modify this value.

FIG. 1A of the drawings illustrates a LE audio system depicting a broadcast source 101 as a source device, broadcast sinks 105A and 105B as one or more sink devices, and broadcast assistants 103A, 103B as assistants to the one or more sink devices, in accordance with an existing state of the art. There may be many sink devices that can be synchronized to the source device. When a user carrying the sink devices moves out of range of the broadcast source device, the user hears audio choppiness. Also, since Bluetooth operates in an unlicensed ISM band at 2.4 GHz, it may face interference from other wireless technologies (WLAN, DECT, etc.), so there arises a need for updating frequency channels to be used at the source device side. Further, unlike connection oriented channels, Broadcast Channels are unreliable as there is no acknowledgment mechanism. Though Bluetooth SIG specification adds limited retransmission ability in the Broadcast Source device, it is generally fixed and there is no awareness in Broadcast Source of the RF environment. Also, since the limited retransmission is fixed, the isochronous data packets may be retransmitted unnecessarily and may cause more battery consumption at the Broadcast Source device side.

Therefore, there lies a need for a method and system that can improve audio quality in the LE audio broadcast scenario.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a system and method for managing the audio quality in the LE audio broadcast scenario by a source device.

Additional aspects will be set forth in part in the description which follows and, in part, will be apparent from the description, or may be learned by practice of the presented embodiments.

In accordance with an aspect of the disclosure, a method for managing the audio quality in the audio broadcast scenario performed by the source device is provided. The method includes reserving a receiver (Rx) slot in the source device to receive link quality feedback data packets from one or more sink devices. The reserved Rx slot includes Rx slot information. The method further includes transmitting the Rx slot information to the one or more sink devices in a control subevent of a Broadcast Isochronous Stream (BIS) event and receiving the link quality feedback data packets from the one or more sink devices in the reserved Rx slot in response to the transmitted Rx slot information. The method further includes determining a quality of a broadcast link between the source device and the one or more sink devices by scanning the received link quality feedback data packets and thereafter based on a result of the determination, optimizing at least one of a plurality of LE isochronous parameters to manage the quality of the broadcast link.

In accordance with another aspect of the disclosure, a system for managing the audio quality in the audio broadcast scenario is provided. The system includes a source device that includes at least one controller and one or more sink devices. The at least one controller is configured to reserve a receiver (Rx) slot in the source device to receive link quality feedback data packets from the one or more sink devices. The reserved Rx slot includes Rx slot information. The at least one controller is further configured to transmit the Rx slot information to the one or more sink devices in a control subevent of a Broadcast Isochronous Stream (BIS) event and receive the link quality feedback data packets from the one or more sink devices in the reserved Rx slot in response to the transmitted x slot information. The at least one controller is further configured to determine a quality of a broadcast link between the source device and the one or more sink devices by scanning the received link quality feedback data packet, and thereafter based on the result of the determination, optimize at least one of a plurality of LE isochronous parameters to manage the quality of the broadcast link.

In accordance with another aspect of the disclosure, a system for managing the audio quality in the audio broadcast scenario is provided. The system includes a source device, one or more sink devices, and a plurality of broadcast assistant devices each including at least one controller. The plurality of broadcast assistant devices includes a primary broadcast assistant device. The one or more sink devices are configured to transmit link quality feedback data packets to the plurality of broadcast assistant devices. Further, the at least one controller of each of the plurality of broadcast assistant devices is configured to form a family group of the plurality of broadcast assistant devices using a user account registered on a corresponding broadcast assistant device of the plurality of broadcast assistant devices. Further, the at least one controller of the primary broadcast assistant device is configured to scan the link quality feedback data packets to determine a quality of a broadcast link between the source device and the one or more sink devices, establish a LE-based connection with the source device, and then transmit a result of the determination of the quality of the broadcast link to the source device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other features, aspects, and advantages of the disclosure will be more apparent from the following description taken in conjunction with the accompanying drawings, in which:

FIG. 1A illustrates a LE audio system depicting a broadcast source as a source device, broadcast sinks as one or more sink devices, and broadcast assistants as assistants to the one or more sink devices, according to the related art;

FIG. 1B is a block diagram depicting a hardware configuration of the source device, according to an embodiment of the disclosure;

FIG. 2 is a block diagram illustrating a system architecture for managing the audio quality in the audio broadcast scenario, according to an embodiment of the disclosure;

FIG. 3 illustrates a flowchart of method operations for managing audio quality in the LE audio broadcast scenario, according to an embodiment of the disclosure;

FIG. 4 illustrates an example time reference graph indicating control events and subevent of a Broadcast Isochronous Group (BIG) event and a BIS event, according to an embodiment of the disclosure;

FIG. 5A illustrates a time reference graph of the BIG receive event, according to an embodiment of the disclosure;

FIG. 5B illustrates a time reference graph indicating a division of the last subevent of a BIG receive event to receive the link quality feedback data packets according to an embodiment of the disclosure;

FIG. 6 illustrates a detailed flowchart of method operations for optimizing one or more LE isochronous parameters in the LE audio broadcast scenario, according to an embodiment of the disclosure;

FIG. 7 illustrates another implementation example of the audio system, according to an embodiment of the disclosure; and

FIG. 8 illustrates a detailed flowchart of method operations for optimizing one or more LE isochronous parameters in the LE audio broadcast scenario with reference to FIG. 7, according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “some” as used herein is defined as one, or more than one, or all.” Accordingly, the terms “one,” “more than one,” or “more than one,” or “all” would all fall under the definition of “some.” The term “some embodiments” may refer to one embodiment or several embodiments or all embodiments. Accordingly, the term “some embodiments” is defined as meaning “one embodiment, or more than one embodiment, or all embodiments.”

The terminology and structure employed herein are for describing, teaching, and illuminating some embodiments and their specific features and elements and do not limit, restrict, or reduce the spirit and scope of the claims or their equivalents.

More specifically, any terms used herein such as but not limited to “includes,” “including,” “comprises,” “has,” “have” and grammatical variants thereof do NOT specify an exact limitation or restriction and certainly do NOT exclude the possible addition of one or more features or elements, unless otherwise stated, and must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element do NOT preclude there being none of that feature or element unless otherwise specified by limiting language such as “there NEEDS to be one or more . . . ” or “one or more element is required.”

The term “module” and “engine” used in the document may imply a unit including, for example, one of hardware, software, and firmware or a combination of two or more of them. The “module” and “engine” may be interchangeably used with a term such as logic, a logical block, a component, a circuit, and the like. The “module” and “engine” may be a minimum system component for performing one or more functions or may be a part thereof. For example, the “module” and “engine” of the disclosure may include at least one of an Application-Specific Integrated Circuit (ASIC) chip, a Field-Programmable Gate Arrays (FPGAs), a programmable-logic device, or a combination of programmable-logic devices which are known or will be developed, and which perform certain operations.

Unless otherwise defined, all terms, and especially any technical and/or scientific terms, used herein may be taken to have the same meaning as commonly understood by one having ordinary skill in the art.

Embodiments of the disclosure will be described below in detail with reference to the accompanying drawings.

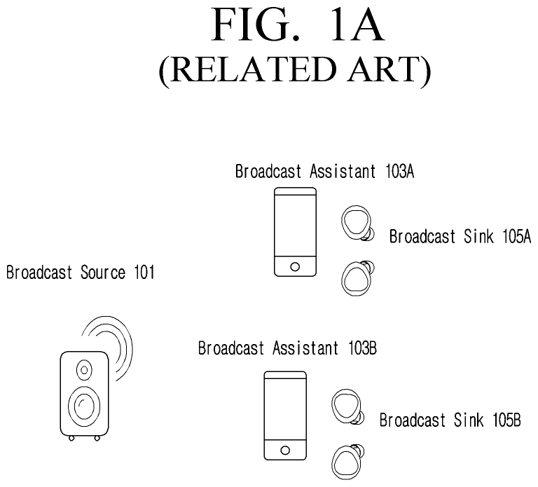

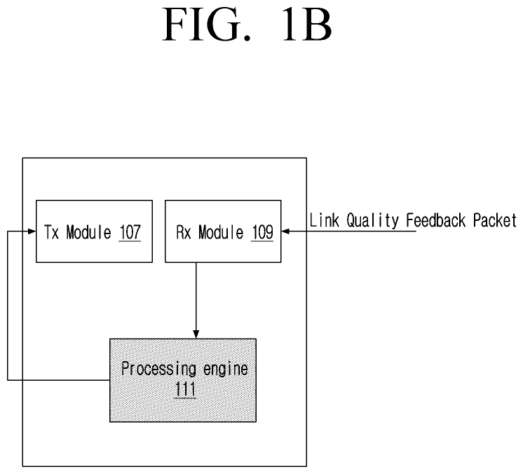

FIG. 1B is a block diagram depicting a hardware configuration of the source device, according to an embodiment of the disclosure.

The source device corresponds to one of a television, an audio reproduction system, or a portable electronic device that can transmit audio packets to one or more sink devices. Here, the one or more sink devices may correspond to one of but is not limited to, wireless earbuds, TWS, Bluetooth earphones, or a wireless headset. The one or more sink devices may correspond to any earpiece device configured to reproduce audio.

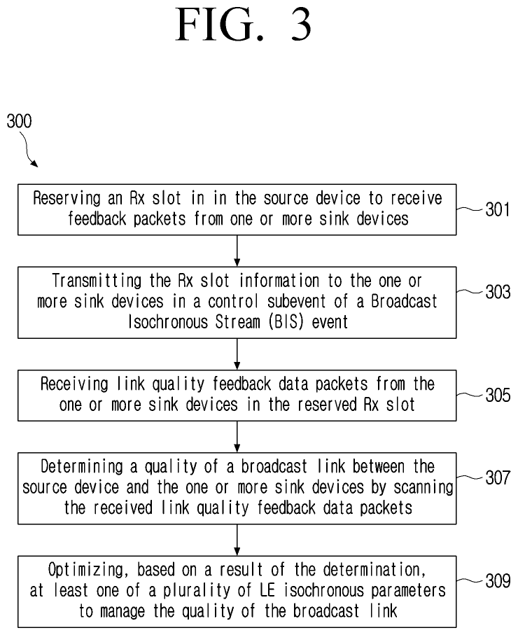

The hardware configuration of the source device includes a transmitter (Tx) module 107, a receiver (Rx) Module 109, and a processing engine 111 such as a central processing unit (CPU), a processing circuitry, one or more controllers, and the like, and that is configured to control overall operations performed by the source device. The processing engine 111 is configured to reserve a receiver (Rx) slot in the source device to receive link quality feedback data packets from one or more sink devices. The reserved Rx slot includes Rx slot information. The processing engine 111 is configured to transmit the Rx slot information to the one or more sink devices in a control subevent of a Broadcast Isochronous Stream (BIS) event using the Tx module 107. The processing engine 111 is further configured to receive the link quality feedback data packets from the one or more sink devices in the reserved Rx slot in response to the transmitted Rx slot information. A more detailed description of the operations and functionalities of the processing engine is described below with reference to FIGS. 3, 4, 5A, 5B, and 6 of the drawings.

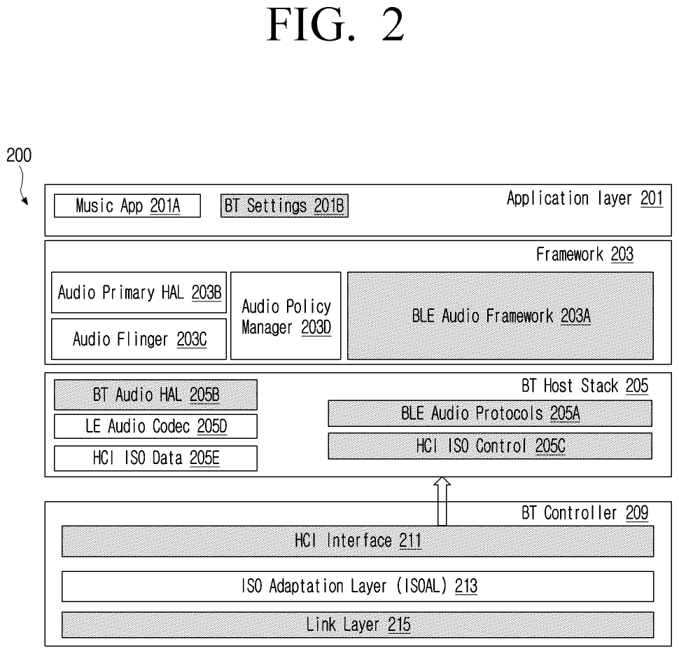

FIG. 2 is a block diagram illustrating a system architecture 200 of an audio system for managing the audio quality in the audio broadcast scenario, according to an embodiment of the disclosure.

The audio system includes an application layer 201, a framework layer 203 to provide access to low-level audio components, a Bluetooth (BT) Host Stack 205, a BT controller 209, and a Vendor Specific Event (VSE) 207 which is received by the BT Host Stack 205 from the BT controller 209. The BT controller 209 includes a Host Controller Interface (HCI) 211, Isochronous Adaptation Layer (ISOAL) 213, and a link layer 215. The BT Host Stack 205 includes Bluetooth Low Energy (BLE) Audio Protocols 205A, HCI ISO Control 205C, BT Audio HAL 205B, LE Audio Codec 205D, and HCI ISO Data 205E.

The framework layer 203 includes BLE Audio Framework 203A, Audio Primary audio hardware abstraction layer (HAL) 203B, Audio Flinger 203C, and an Audio Policy Manager 203D. The BLE Audio Framework 203A is responsible to interact with the BT Audio HAL 205B to send Link Quality Information to the BT Audio HAL 205B. Additionally, the Link Quality-quality of service (QOS) Mapping table can be defined and passed to the BT Audio HAL 205B. The Audio Primary HAL 203B defines a basic interface layer between the audio related drivers for the Audio Policy Manager 203D. Where the Audio Policy Manager 203D defines one or more APIs to access and control underlying audio system subcomponents. The Audio Flinger 203C corresponds to a sound server implementation. The Audio Flinger 203C runs within a media server process.

The HCI 211 is a standardized Bluetooth interface for sending commands, receiving events, and for sending and receiving data. It is typically realized as a serial interface, using either RS232 or USB communication devices. As the name implies, the HCI is used to bridge the BT Host Stack 205 and the controller devices such as the BT controller 209. commands and events can either be specified or can be vendor specific for extensibility.

The HCI ISO Control 205C and the HCI 211 create a new HCI vendor specific event to inform the BT Host Stack 205 when there is a change in audio link state transition. Also, a new Link Quality Profile/Service can be defined using the BLE Audio Protocols 205A of the BT Host Stack 205 to interact with a primary broadcast assistant device to receive link quality notifications. The BLE Audio Protocols 205A is configured to enable/disable the broadcast quality improvement feature. The user of the audio system has the option to enable/disable the feature. When the broadcast quality improvement feature is enabled, the BT controller 209 will enter mode to enable receiving audio Link quality feedback data packets and sends to the host. When the broadcast quality improvement feature is disabled, the BT controller 209 is stopped to receive the audio Link quality feedback data packets and sending the link information to the host. Additionally, when the broadcast quality improvement feature is enabled, a timer can also be set to inform the BT controller 209 how often it needs to evaluate link quality.

The application layer 201 includes one or more music applications 201A and BT setting 201B. The BT setting 201B includes user interface options to control the enabling operation of the Broadcast Quality Improvement feature. Additionally, the BT setting 201B may include a selection option to select Primary Broadcast Assistant among the family member list of audio devices.

The BT Audio HAL 205B of the BT Host Stack 205 is configured to receive link quality feedback information and configure LE audio codec configuration to meet the audio quality requirements such as but not limited to the sampling frequency, frame duration, Octets per codec frame, etc. The LE Audio Codec 205D may correspond to one of a Low Complexity Communication Codec (LC3). This codec is configured to compress the audio data packets for transmission over the air.

The BT controller 209 may act as the processing engine 111 of FIGS. 1A and 1B and controls the overall operation of the audio system in combination with the subcomponents of FIGS. 1A, 1B, and 2.

The ISOAL 213 enables the lower and upper layers of the stacks as shown in FIG. 2 to work together. The ISOAL 213 provides segmentation, fragmentation, reassembly and recombination services for conversion of service data units (SDUs) from the upper layer to Protocol Data Units (PDUs) of the Link Layer and vice versa. The ISOAL 213 accepts or generates SDUs, each with a length up to the maximum length (Max_SDU), at a rate that is supported by the BT controller 209. SDUs are transferred to and from the upper layer using either HCI ISO Data 205E or over an implementation-specific transport.

The Link layer 215 is responsible for reserving the Rx Slot in the source device for receiving link quality feedback data packets under the control of the BT controller 209. The Link layer 215 is also responsible to control QoS Parameters for Broadcast (BIS).

FIG. 3 illustrates a flowchart of method operations for managing audio quality in the LE audio broadcast scenario, according to an embodiment of the disclosure. FIG. 3 depicts a method 300 that is executed by the BT controller 209 of FIG. 2 or processing engine 111 of FIG. 1B of the drawings.

Referring to FIG. 3, the method 300 at operation 301, comprises reserving a receiver (Rx) slot in the source device to receive link quality feedback data packets from the one or more sink devices. As an example, the BT controller 209 reserves the Rx Slot in the source device using the link layer 215 for receiving link quality feedback data packets from the one or more sink devices. The reserved Rx slot includes Rx slot information. The flow of the method 300 now proceeds to operation 303).

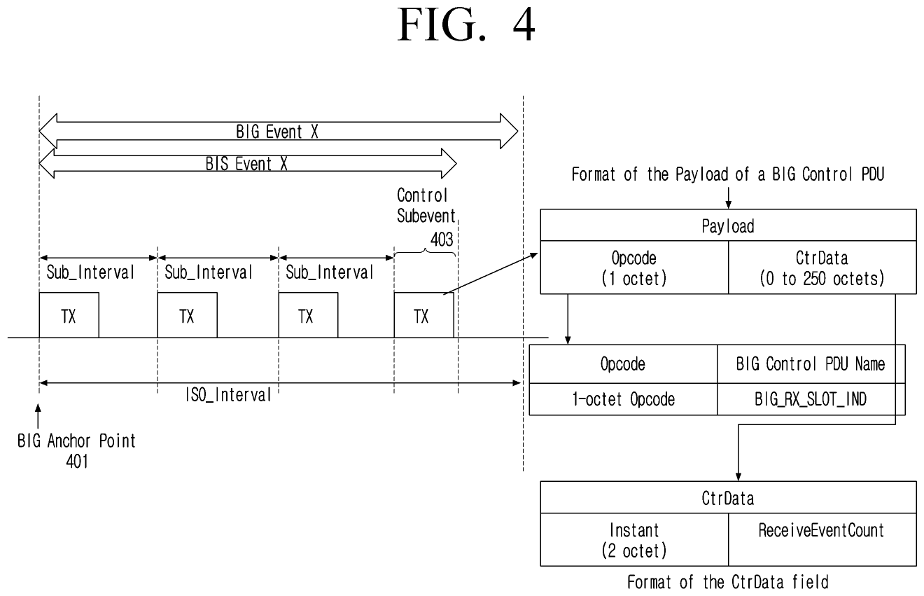

At operation 303, the method 300 comprises transmitting the Rx slot information to the one or more sink devices in a control subevent of a Broadcast Isochronous Stream (BIS) event. As an example, the BT controller 209 periodically transmits the Rx slot information (to the one or more sink devices in the control subevent of the BIS event via the Tx module 107. The periodicity (interval) can vary based on the link quality feedback data packets from the one or more sink devices. The Rx slot information indicates timing information about when the source device will open its Rx Slot for listening to the link quality feedback data packets from the one or more sink devices. An example of the control subevent of the BIS event is illustrated in FIG. 4 of the drawings for ease of explanation.

FIG. 4 illustrates an example time reference graph indicating control events and subevent of a Broadcast Isochronous Group (BIG) event and a BIS event, according to an embodiment of the disclosure.

Referring to FIG. 4, a BIG event includes two or more BISs having the same ISO interval and that is expected to have a time relationship at the application layer 201, or of a single BIS. For each BIS within a BIG event, a schedule of transmission time slots, i.e., events and subevents are present. Each BIS event starts at a BIS anchor point and ends after its last subevent and each BIG event starts at a BIG anchor point 401 and ends after the control subevent 403. A BIS subevent enables an isochronous broadcaster to transmit a BIS Protocol Data Unit (PDU) and enables the Rx module 109 to receive it. A format of the payload of a BIG Control PDU is shown on the right-hand side of FIG. 4. The Opcode field of the payload specifies different types of BIG control PDUs. The Opcode field also specifies the CtrData field in the payload of BIG control PDU. For a given Opcode, the length of the CtrData field is fixed. The Instant field of the CtrData shall be set to the value of bigEventCounter15-0 which is used by Synchronized receivers to track the Rx event slot. The Rx slot will open in the event which appears after ReceiveEventCount events after the Instant event.

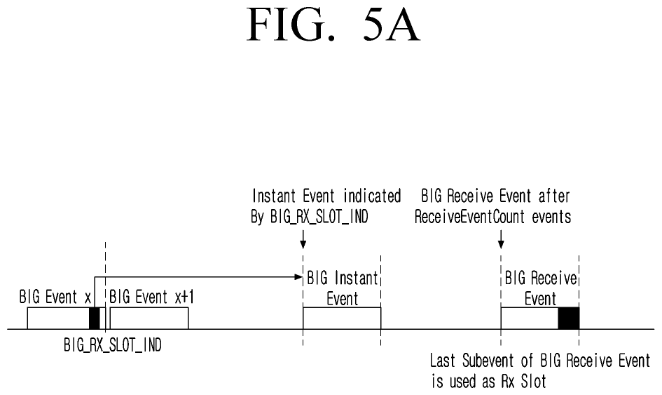

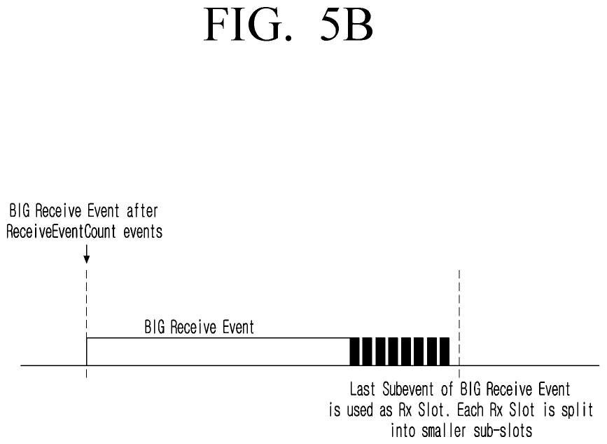

FIG. 5A illustrates a time reference graph of the BIG receive event, according to an embodiment of the disclosure.

Referring to FIG. 5A, BIG_RX_SLOT_IND indicates a BIG Control PDU received in the control subevent of BIG Event x, the BIG instant event indicates an instant value of the BIG_RX_SLOT_IND, and the BIG receive event is a combination of the BIG instant event and the ReceiveEventCount value of the BIG_RX_SLOT_IND. The portion that is highlighted in black color indicates the last subevent of the BIG receive event that is used as the Rx slot.

Further, in accordance with some embodiment of the disclosure, the reserved Rx slot includes a plurality of sub-slots to receive the link quality feedback data packets from the one or more sink devices. The number of sub-slots and the duration of each sub-slot are determined by the source device. This information is shared with all the sink devices in the BIG_RX_SLOT_IND control PDU. Further, to avoid collision, the source device may use a different RF frequency channel for each sub-slot.

FIG. 5B illustrates a time reference graph where the last subevent of the BIG receive event is divided into a plurality of time slots to receive the link quality feedback data packets from the one or more sink devices according to an embodiment of the disclosure. The flow of the method 300 now proceeds to operation 305.

At the operation 305, subsequent to the transmission of the Rx slot information to the one or more sink devices, the method 300 comprises receiving the link quality feedback data packets from the one or more sink devices in the reserved Rx slot. As an example, the source device receives the link quality feedback data packets from the one or more sink devices in the reserved Rx at the timing indicated by the timing information in the transmitted Rx slot information. The link quality feedback data packets include feedback information regarding the quality of a broadcast link between the source device and the one or more sink devices. The flow of the method 300 now proceeds to operation 307.

At the operation 307, after the reception of the link quality feedback data packets by the source device, the method 300 comprises determining a quality of a broadcast link between the source device and the one or more sink devices by scanning the received link quality feedback data packets. A result of the determination of the quality of the broadcast link is an indicator of a Tx quality of audio data packets to the one or more sink devices. As an example, the BT controller 209 is configured to scan the received link quality feedback data packets and fetch feedback information related to a Tx quality of audio data packets from the source device to the sink devices based on the scanning. Thereafter, the BT controller determines the quality of the broadcast link between the source device and the one or more sink devices using the feedback information related to the Tx quality of the audio data packets that are fetched from the received link quality feedback data packets. The flow of the method 300 now proceeds to operation 309.

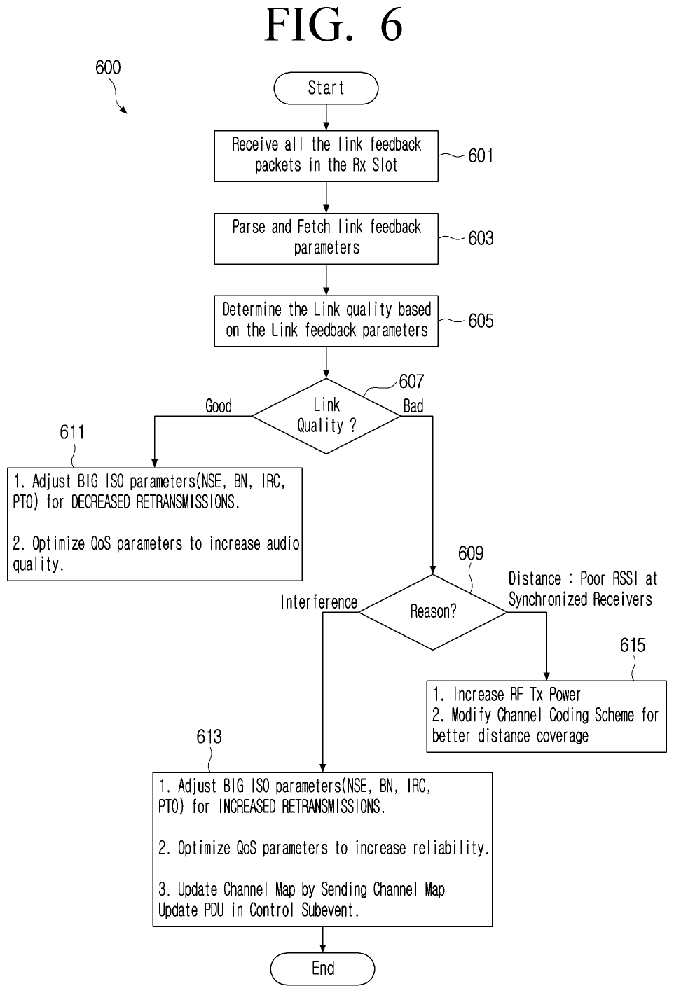

At the operation 309, subsequent to the determination of the quality of the broadcast link, the method 300 comprises optimizing at least one of one or more LE isochronous parameters based on the result of the determination of the quality of the broadcast link. The one or more LE isochronous parameters include but are not limited to, a number of Subevents (NSE), Burst Number (BN), Immediate Retransmission Count (IRC), and Pre-Transmission Offset (PTO) used for broadcasting the audio data packets. The optimization of the at least one of the one or more LE isochronous parameters helps in managing the quality of the broadcast link. An example of the optimization process will now be explained with reference to the method flow chart of FIG. 6 of the drawings.

FIG. 6 illustrates a detailed flowchart of method operations for optimizing one or more LE isochronous parameters in the LE audio broadcast scenario, according to an embodiment of the disclosure.

It is to be noted that operation 601 and a combination of operations 603 and 605 of the method 600 are similar to operations 305 and 307 of the method 300, respectively. Therefore, a description of the same is omitted herein for the sake of uniformity and simplicity of the disclosure.

Further, at operation 607, the BT controller 209 determines whether the quality of the broadcast link is good or bad by comparing the determined quality of the broadcast link with a predefined threshold value. In case the result of the determination at operation 607 indicates that the determined quality of the broadcast link is less than the predefined threshold value then it means that the quality of the broadcast link is bad. Further, the flow of the method 600 proceeds to operation 609.

At operation 609, the BT controller 209 is configured to determine a reason behind the bad quality of the broadcast link. If it is determined that the reason behind the bad quality of the broadcast link is interference, then in that case the BT controller 209 at operation 613 is further configured to optimize the one or more LE isochronous parameters to increase the Retransmission Number (RTN) to improve packet reception at the one or more sink devices. In particular, the BT controller 209 may change a value of the IRC. The value of the IRC is controlled by the BT controller 209 by adjusting ISO parameters like NSE and BN.

In case the result of the determination at operation 607 indicates that the determined quality of the broadcast link is less than the predefined threshold value then it means that the quality of the broadcast link is bad. In such a case, the BT controller 209 may increase a periodicity of the transmission of the reserved Rx slot information to the one or more sink devices.

In accordance with some embodiment of the disclosure, the BT controller 209, at operation 613, may also update channel map information of audio data packets in the case the determined quality of the broadcast link is bad and the reason behind the bad broadcast link is interference. The reason behind the bad broadcast link is determined based on the information included in the received link quality feedback data packets. Further, the BT controller 209 transmits, via the Tx module 107, the updated channel map information to the one or more sink devices in a PDU in the control subevent.

However, if at operation 609 it is determined that the reason behind the bad quality of the broadcast link is the poor RSSI at the one or more sink devices, then in that case the BT controller 209, at operation 615, is further configured to modify channel coding scheme of the audio data packets and transmit the audio data packets having the modified channel coding scheme to the one or more sink devices. Also, if it is determined that a greater number of packets indicates poor RSSI strength then in such case, the BT controller 209, at operation 615, may increase the Tx Power of the source device. Here, the poor RSSI strength means that the one or more sink devices are located at a far distance from the source device.

Further, in a case, if the result of the determination at operation 607 indicates that the determined quality of the broadcast link is greater than the predefined threshold value then it means that the quality of the broadcast link is good. Therefore, in such a case at operation 611, the BT controller 209 is configured to optimize the plurality of one or more isochronous parameters to decrease the RTN. In particular, the BT controller 209 may change a value of the IRC. The value of the IRC is controlled by the BT controller 209 by adjusting ISO parameters like NSE and BN. The decrease in IRC is intended to reduce unnecessary retransmission of audio packets to the one or more sink devices and results in a reduction in power consumption at the source device.

In accordance with an embodiment of the disclosure, if the quality of the broadcast link is good, then the BT controller 209, at operation 611, may also optimize QOS parameters like but not limited to the sampling frequency, SDU Interval, Max SDU size, etc. to increase the quality of the audio sound to be reproduced at the one or more sink devices. For e.g., the audio quality is better in case of sampling rate 48K>44.1K>32K>16K>8K.

In case the result of the determination at operation 607 indicates that the determined quality of the broadcast link is greater than the predefined threshold value then it means that the quality of the broadcast link is good. In such a case, the BT controller 209 may decrease a periodicity of the transmission of the reserved Rx slot information to the one or more sink devices.

In view of the above-described embodiments, due to the optimization of the more LE isochronous parameters, QoS parameters, channel coding scheme, and controlling retransmissions of audio packets in accordance with real-time link quality feedback information, it became possible to improve the audio quality in the LE audio broadcast scenario and also the unnecessary retransmission of the isochronous data packets is restricted. Further, due the optimization as per the method and system of the disclosure also results in reducing the power consumption at the source device side. Thus, the method and audio system of the disclosure results in improvement of the audio quality and reliability in the LE audio broadcast scenario where there is no acknowledgment mechanism and is generally unreliable.

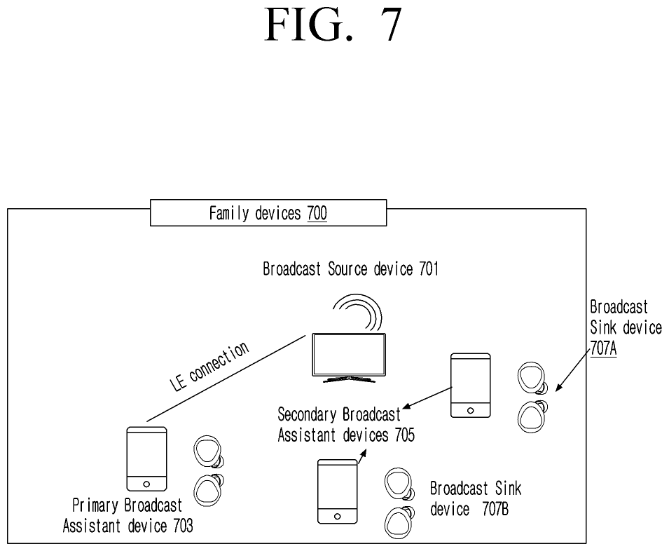

FIG. 7 illustrates another implementation example of the audio system, according to an embodiment of the disclosure.

Referring to FIG. 7, the audio system includes a family of devices 700 including a Broadcast Source Device 701, a plurality of smart assistant devices including Primary Broadcast Assistant Device 703 and Secondary Broadcast Assistant devices 705, and one or more broadcast sink devices including Broadcast Sink Device 707A and Broadcast Sink Device 707B. Here, two sink devices and two secondary smart assistant devices are used as an example. However, a number of the secondary smart assistant devices and the sink devices can be changed as per other configurations of the audio systems. Therefore, those skilled in the art will appreciate that the aforementioned example of the audio system is merely exemplary and is not intended to limit the scope of the disclosure.

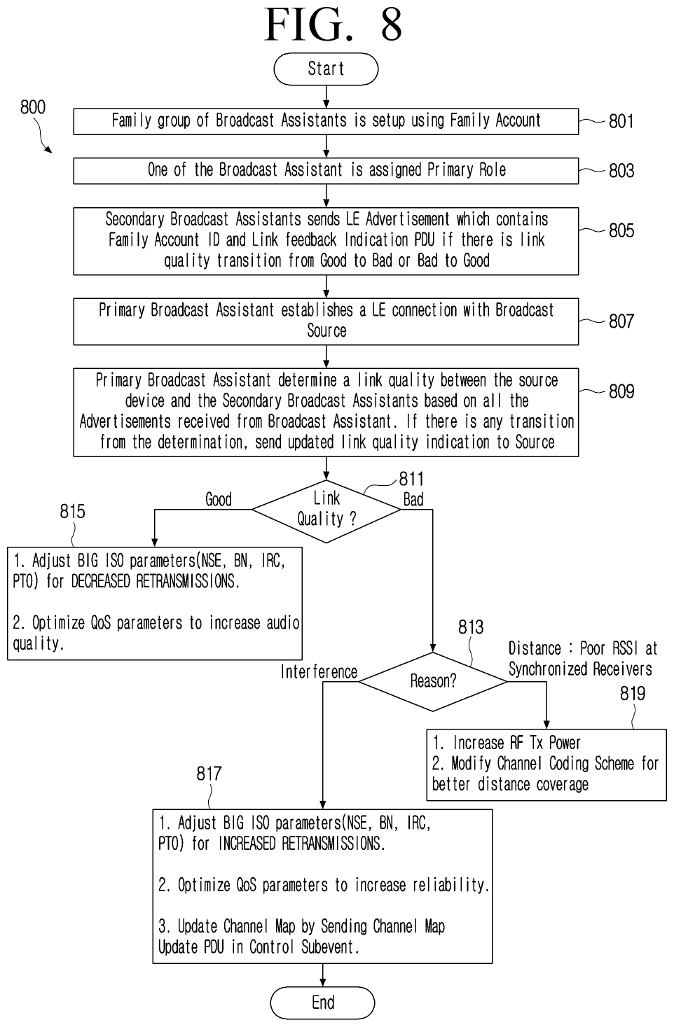

Each of the Broadcast Source Device 701, Primary Broadcast Assistant Device 703, and Secondary Broadcast Assistant devices 705 may include the processing engine 111 or the BT controller as described above in FIGS. 1B and 2 to control operations and communication between each other. A detailed operation and functionalities of the processing engine 111 or the BT controller 209 in accordance with FIG. 7 will be explained in detail with the help of method 800 of FIG. 8 of drawings.

FIG. 8 illustrates a detailed flowchart of method operations for optimizing one or more LE isochronous parameters in the LE audio broadcast scenario with reference to FIG. 7, according to an embodiment of the disclosure.

At operation 801 of the method 800, the BT controller 209 or processing engine 111 of each of the broadcast assistant devices (E.g., Primary Broadcast Assistant Device 703 and each of the Secondary Broadcast Assistant devices 705) is configured to form a family group of the broadcast assistant devices using a user account registered on a corresponding broadcast assistant device of the broadcast assistant devices.

At operation 803, the BT controller 209 or processing engine 111 of the Broadcast Source Device 701 is configured to assign a primary role to one of the Broadcast Assistant devices and the assistant device to which the primary role is assigned can be referred to as the Primary Broadcast Assistant device.

At operation 805, the BT controller 209 of the Secondary Broadcast Assistant devices 705 sends, to the Primary Broadcast Assistant Device 703, LE advertisement which contains family Account ID and link quality feedback data packets having PDU indicating a link quality transition from good to bad or bad to good.

At operation 807, the BT controller 209 of the Primary Broadcast Assistant Device 703 establishes a LE connection with the Broadcast Source Device 701. Thereafter, at operation 809, the BT controller 209 of the Primary Broadcast Assistant Device 703 determines the quality of the broadcast link between the Broadcast Source Device 701 and the Broadcast Sink Devices 707A and 707B based on all the Advertisements received from Broadcast Assistant Devices. Further, the BT controller 209 of the Primary Broadcast Assistant Device 703 may also determine whether the determined quality of the broadcast link is transitioned from bad to good or good to bad. If it is determined that there is a transition in the broadcast link quality then, the BT controller 209 of the Primary Broadcast Assistant Device 703 sends an updated link quality indication to the Broadcast Source Device 701 via the established LE connection.

Further, at operation 811, the BT controller 209 of the Primary Broadcast Assistant Device 703 may determine whether the determined quality of the broadcast link is good or bad by comparing it with the predefined threshold value, and on a basis of the result of this determination, the method operations 811, 813, 817, 819, and 815 are performed. Each of the operations performed by the BT controller 209 of the Primary Broadcast Assistant Device 703 at the method operations 811, 813, 817, 819, and 815 are similar to that of the method operations 607, 609, 613, 615, and 611, respectively. Therefore, the description of the method operations 811, 813, 817, 819, and 815 are omitted herein for the sake of uniformity and simplicity of the disclosure.

The audio system and method of the disclosure can be used in a variety of applications such as, but are not limited to, sharing of personal music from a smartphone to friends by sending music streams to multiple users, in educational microphones by sending voice stream to multiple users, location-based audio sharing in a gym, silent disco, and in a place where loud sound is prohibited. Those skilled in the art will appreciate that the aforementioned use case examples of the audio system and the above-described method for improving the audio quality are merely exemplary and are not intended to limit the scope of the disclosure.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for managing audio quality in low energy (LE) audio broadcast scenario performed by a source device, the method comprising:
reserving a receiver (Rx) slot in the source device to receive link quality feedback data packets from one or more sink devices, wherein the reserved Rx slot includes Rx slot information;
transmitting the Rx slot information to the one or more sink devices in a control subevent of a broadcast isochronous stream (BIS) event;
receiving the link quality feedback data packets from the one or more sink devices in the reserved Rx slot;
determining a quality of a broadcast link between the source device and the one or more sink devices by scanning the received link quality feedback data packets; and
optimizing, based on a result of the determination, at least one of a plurality of LE isochronous parameters to manage the quality of the broadcast link.

2. The method as claimed in claim 1, wherein the Rx slot information indicates timing information regarding a time period after which the source device will open the reserved Rx slot for listening to the link quality feedback data packets from the one or more sink devices.

3. The method as claimed in claim 1, wherein a result of the determination of the quality of the broadcast link is an indicator of a Tx quality of audio data packets to the one or more sink devices.

4. The method as claimed in claim 1, wherein the Rx slot information is transmitted periodically to the one or more sink devices.

5. The method as claimed in claim 4, further comprising:
optimizing, to increase a periodicity of the transmission of the Rx slot information to the one or more sink devices, the plurality of LE isochronous parameters in a case in which the determined quality of the broadcast link is less than a predefined threshold value.

6. The method as claimed in claim 4, further comprising:
optimizing, to decrease a periodicity of the transmission of the Rx slot information to the one or more sink devices, the plurality of LE isochronous parameters in a case in which the determined quality of the broadcast link is greater than a predefined threshold value.

7. The method as claimed in claim 1, further comprising:
adjusting, in a case in which the determined quality of the broadcast link is less than a predefined threshold value, a retransmission number (RTN) of audio data packets to increase a reception rate of audio data packets at the one or more sink devices.

8. The method as claimed in claim 1, further comprising:
adjusting, in a case in which the determined quality of the broadcast link is greater than a predefined threshold value, a retransmission number (RTN) of audio data packets to decrease retransmissions of audio data packets to the one or more sink devices.

9. The method as claimed in claim 1, further comprising:
optimizing, in a case in which the determined quality of the broadcast link is greater than a predefined threshold value, quality of service (QOS) parameters to enhance audio quality of sound that is being reproduced at the one or more sink devices.

10. The method as claimed in claim 1, further comprising:
increasing a Tx Power of the source device if a greater number of packets indicate poor received signal strength indicator (RSSI) strength indicating that the one or more sink devices are located at a far distance from the source device.

11. The method as claimed in claim 1, wherein the plurality of LE isochronous parameters includes at least one of a number of subevents (NSE), burst number (BN), an immediate retransmission count (IRC), or a pre-transmission offset (PTO) used for broadcasting audio data packets.

12. The method as claimed in claim 1, further comprising:
modifying channel coding scheme of audio data packets in a case in which the determined quality of the broadcast link is below a predefined threshold value and the received link quality feedback data packets indicate a poor received signal strength indicator (RSSI) at the one or more sink devices; and
transmitting the audio data packets having the modified channel coding scheme to the one or more sink devices.

13. The method as claimed in claim 1, further comprising:
updating channel map information of audio data packets in a case in which the determined quality of the broadcast link is below a predefined threshold value and the received link quality feedback data packets indicate a presence of interference; and
transmitting, to the one or more sink devices, the updated channel map information in a PDU in the control subevent.

14. A system for managing audio quality in low energy (LE) audio broadcast scenario, the system comprising:
a source device that includes at least one controller; and
one or more sink devices, wherein the at least one controller is configured to:
reserve a receiver (Rx) slot in the source device to receive link quality feedback data packets from the one or more sink devices, wherein the reserved Rx slot includes Rx slot information,
transmit the Rx slot information to the one or more sink devices in a control subevent of a broadcast isochronous stream (BIS) event,
receive the link quality feedback data packets from the one or more sink devices in the reserved Rx slot,
determine a quality of a broadcast link between the source device and the one or more sink devices by scanning the received link quality feedback data packets, and
optimize, based on a result of the determination, at least one of a plurality of LE isochronous parameters to manage the quality of the broadcast link.

15. A system for managing audio quality in low energy (LE) audio broadcast scenario, the system comprising:
a source device;
one or more sink devices; and
a plurality of broadcast assistant devices each including at least one controller,
wherein the plurality of broadcast assistant devices includes a primary broadcast assistant device,
wherein the one or more sink devices are configured to transmit link quality feedback data packets to the plurality of broadcast assistant devices,
wherein the at least one controller of each of the plurality of broadcast assistant devices is configured to form a family group of the plurality of broadcast assistant devices using a user account registered on a corresponding broadcast assistant device of the plurality of broadcast assistant devices, and
wherein at least one controller of the primary broadcast assistant device is configured to:
scan the link quality feedback data packets to determine a quality of a broadcast link between the source device and the one or more sink devices,
establish an LE-based connection with the source device, and
transmit a result of the determination of the quality of the broadcast link to the source device.

16. The system of claim 15, wherein the source device is configured to designate the primary broadcast assistant device from among the plurality of broadcast assistant devices.

17. The system of claim 15, wherein the at least one controller of the primary broadcast assistant device is configured to:
in a case in which the quality of the broadcast link between the source device and the one or more sink devices transitions from above a predefined threshold value to below the predefined threshold value, transmit, to the source device, an updated link quality indication via the LE-based connection.
